(19) United States
(12) Patent Application Publication
(10) Pub. No.: US 2006/0114184 A1
(43) Pub. Date: Jun. 1, 2006

(54) Plasma display device and driving method for stabilizing address discharge by varying sustain electrode voltage levels

(76) Inventor: Myoung-Kwan Kim, Suwon-si (KR)

Correspondence Address: CHRISTIE, PARKER & HALE, LLP, PO BOX 7068, PASADENA, CA, 91109-7068, US

(21) Appl. No.: 11/194,953

(22) Filed: Aug. 1, 2005

(30) Foreign Application Priority Data
Nov. 9, 2004 (KR) 10-2004-0090849

(51) Int. Cl. G09G 3/28

(52) U.S. Cl. 345/67

(57) ABSTRACT

Driving a plasma display device by a plurality of subfields divided from a frame, when different driving waveforms are applied during reset periods of the plurality of subfields. A defective address operation that may be caused by an unstable wall charge state remaining at the end of the reset period may be prevented by adjusting the bias voltage applied to sustain electrodes, during the address periods, depending on the driving waveforms of the preceding reset periods.

### CROSS-REFERENCE TO RELATED APPLICATION

This application claims priority to and the benefit of Korean Patent Application 10-2004-0090849 filed in the Korean Intellectual Property Office on Nov. 9, 2004, the entire content of which is incorporated herein by reference.

### BACKGROUND OF THE INVENTION

1. Field of the Invention

The present invention relates to a plasma display device, and more particularly, to a driving method for stable generation of an address discharge.

2. Description of the Related Art

A plasma display device is a flat panel display that uses plasma generated by a gas discharge process to display characters or images. It includes a plasma display panel (PDP) where tens to millions of pixels are provided in a matrix format, depending on the size of the PDP.

According to a typical driving method of a PDP, each frame is divided into a plurality of subfields, and displayed images are represented by a combination of the subfields. Each subfield has a reset period, an address period, and a sustain period. During the reset period, wall charges formed by a previous sustain discharge are erased, and the wall charges are set up so that the next addressing can be stably performed. The address period is for selecting turn-on/turn-off cells (i.e., cells to be turned on or off) and accumulating wall charges on the turn-on cells (i.e., addressed cells). The sustain period is for causing a discharge for actually displaying an image on the addressed cells.

FIG. 1 illustrates a conventional driving waveform of a PDP. Only two subfields among the plurality of subfields are shown for better comprehension and ease of description, and the two subfields are indicated as a first subfield and a second subfield. In addition, FIG. 1 illustrates that a reset period of the first subfield (also called a main reset period) includes a rising period and a falling period, and a reset period of the second subfield (also called an auxiliary reset period) includes only a falling period.

As shown in FIG. 1, during the rising period of the main reset period, a gradually increasing voltage is applied to a scan electrode Y so as to discharge every cell and erase any remaining wall charges from a previous subfield. During the falling period of the main reset period, a voltage gradually decreasing to a negative level Vnf is applied to the scan electrode Y while a sustain electrode X is biased at a constant voltage, therefore inducing wall charges appropriate for addressing during a subsequent address period. That is, during the falling period of the main reset period, negative wall charges are sufficiently formed on the scan electrode Y, and positive wall charges are sufficiently formed on an address electrode A to establish a sufficient wall voltage between the two electrodes. During the address period, a scan pulse of a voltage VscL is sequentially applied to respective scan electrodes Y while the scan electrodes Y are otherwise biased at a voltage VscH. Then, a discharge is generated by a combination of the wall voltage due to wall charges formed on the address and scan electrodes A, Y, and a voltage difference between an address pulse of voltage Va applied to the address electrode A and the pulse of voltage VscL applied to the scan electrode Y. Accordingly, a wall voltage is formed between the scan electrode Y and the sustain electrode X. In addition, a constant bias voltage Ve is applied to the sustain electrode X such that the address discharge is stably maintained by generating a discharge between the scan and sustain electrodes Y, X subsequent to the discharge between the scan and address electrodes Y, A. Subsequently, during the sustain period, sustain discharge pulses alternating between 0V and Vs are applied to the scan electrode Y and the sustain electrode X such that a sustain discharge is generated at cells selected during the address period maintaining and sustaining the discharge generated during the preceding address period.

Subsequently, during the auxiliary reset period of the second subfield, the voltage of the scan electrode Y is gradually decreased from the sustain discharge voltage Vs, applied during the sustain period of the first subfield, to a negative Vnf. As such, the auxiliary reset period includes only a falling period as described above. In this case, because a rising ramp waveform was not established during the auxiliary reset period, negative wall charges are not sufficiently formed on the scan electrode Y and positive wall charges are not sufficiently formed on the address electrode A. Therefore, an address discharge during a subsequent address period may become unstable. Voltage waveforms applied to the various electrodes during the address period and the sustain period of the second subfield are the same as those applied during the first subfield.

As described above, in prior art shown in FIG. 1, the same bias voltage Ve is applied to the sustain electrode X during the address periods following both the main reset period and the auxiliary reset period. The main and auxiliary reset periods may produce different wall charge distributions immediately before their succeeding address periods. Accordingly, an address discharge during the address period succeeding the auxiliary reset period may become unstable when the bias voltage of the sustain electrode X during this address period is kept at the same level as the bias voltage of the sustain electrode X during the address period succeeding the main reset period. In order to solve this problem, a bias voltage level for the sustain electrode X may be determined based on a wall charge state immediately before the address period succeeding the auxiliary reset period. This bias voltage level may be applied to the sustain electrode X during the address period succeeding the main reset period. However, in this case an over-discharge may be generated during an address discharge occurring during the address period after the main reset period.

### SUMMARY OF THE INVENTION

The present invention has been made in an effort to provide a plasma display device and a driving method having an advantage of preventing a misfiring that may be caused by applying a bias voltage to sustain electrodes at a same level regardless of driving waveforms applied in reset periods of subfields.

An exemplary driving method of a plasma display device by a plurality of subfields divided from a frame according to an embodiment of the present invention is for driving a plasma display device having a plurality of first electrodes, a plurality of second electrodes, and a plurality of third electrodes formed in a direction crossing the first and second electrodes, wherein each of the subfields includes sustain, reset, and address periods.

According to the exemplary driving method, in a first subfield, every discharge cell is initialized during the reset period of the first subfield, and then turn-on discharge cells are selected by respectively applying second and third voltages to the first and third electrodes while biasing the second electrodes at a first voltage.

In addition, in a second subfield, the discharge cells selected in a previous subfield are initialized during the reset period of the second subfield, and then turn-on discharge cells are selected by respectively applying second and third voltages to the first and third electrodes while biasing the second electrode at a fourth voltage higher than the first voltage.

An exemplary plasma display device according to an embodiment of the present invention includes a PDP and a driving circuit. The PDP includes a plurality of first electrodes, a plurality of second electrodes, and a plurality of third electrodes formed in a direction crossing the first and second electrodes. The driving circuit supplies a driving signal to the first, second, and third electrodes in a reset period, an address period, and a sustain period.

In a first subfield, the driving circuit initializes every discharge cell during the reset period of the first subfield, and selects turn-on discharge cells by respectively applying second and third voltages to the first and third electrodes while biasing the second electrodes at a first voltage. In addition, in a second subfield, the driving circuit initializes the discharge cells selected in a previous subfield, and selects turn-on discharge cells by respectively applying second and third voltages to the first and third electrodes while biasing the second electrode at a fourth voltage higher than the first voltage.

A driving method of a plasma display device by a plurality of subfields divided from a frame is shown. The plasma display device includes a PDP. The PDP has scan electrodes and sustain electrodes forming parallel pairs, address electrodes extending in a direction crossing the parallel pairs, and discharge cells formed in areas where the address electrodes cross the parallel pairs. Each subfield includes a reset period followed by an address period followed by a sustain period. The driving method includes initializing every discharge cell during a reset period of a first subfield by applying a first voltage waveform to the scan electrodes, selecting a first group of turn-on discharge cells during an address period of the first subfield by applying a second voltage waveform to the scan electrodes and applying a third voltage waveform to the address electrodes, while applying a fourth voltage waveform to the sustain electrodes, initializing the first group of turn-on discharge cells during a reset period of a second subfield by applying a fifth voltage waveform to the scan electrodes, and selecting a second group of turn-on discharge cells during an address period of the second subfield by applying the second voltage waveform to the scan electrodes and applying the third voltage waveform to the address electrodes, while applying a sixth voltage waveform to the sustain electrodes. The fourth voltage waveform includes a first constant bias voltage, the sixth voltage waveform includes a second constant bias voltage, and the second constant bias voltage is more positive than the first constant bias voltage.

In the driving method explained above the first voltage waveform applied to the scan electrodes for initializing every discharge cell may include during the first subfield a gradually increasing voltage and a gradually decreasing voltage. In this driving method the gradually increasing voltage may gradually increase to a positive voltage during the reset period of the first subfield. In this driving method, the fifth voltage waveform applied to the scan electrodes during the second subfield for initializing the turn-on discharge cells may include only a gradually decreasing voltage. In this driving method the gradually decreasing voltage may gradually decrease to a negative voltage during the reset period of the first subfield. In other embodiments, the gradually decreasing voltage may gradually decrease to a negative voltage during the reset period of the second subfield. The first constant bias voltage and the second constant bias voltage may be both positive.

Embodiments of a plasma display device are also shown. The device utilizes the driving method set forth in the above paragraphs.

In other embodiments, a plasma display device is shown that includes a controller for receiving a video signal from an external source and for generating a control signal, a PDP including pixels for displaying images, scan electrodes and sustain electrodes forming parallel pairs, address electrodes crossing the parallel pairs, discharge cells formed at crossings of the address electrodes and the parallel pairs, the plasma display device operating during frames, each frame including subfields, each subfield including a reset period followed by an address period, followed by a sustain period, a scan electrode driver coupled to the controller and to the PDP for receiving the control signal generated by the controller and for applying a scan voltage waveform to the scan electrodes, an address electrode driver coupled to the controller and to the PDP for receiving the control signal generated by the controller and applying an address voltage waveform to the address electrodes, and a sustain electrode driver coupled to the controller and to the PDP for receiving the control signal generated by the controller and for applying a sustain voltage waveform to the sustain electrodes. The controller may vary the sustain voltage waveform of a subfield based on the scan voltage waveform of a previous subfield.

### BRIEF DESCRIPTION OF THE DRAWINGS

FIG. 1 illustrates a conventional driving waveform of a PDP.

FIG. 2 is an electrode arrangement diagram of a PDP according to an embodiment of the present invention.

FIG. 3 is a schematic diagram of a plasma display device according to an embodiment of the present invention.

FIG. 4 illustrates a driving waveform of a plasma display device according to an embodiment of the present invention.

### DETAILED DESCRIPTION

FIG. 2 is an electrode arrangement diagram of a PDP according to an embodiment of the present invention. Electrodes of a PDP are arranged in an n×m matrix format. Address electrodes A₁ to Aₘ are arranged in a column direction, and scan electrodes Y₁ to Yₙ and sustain electrodes X₁ to Xₙ are arranged by pairs in a row direction. A discharge cell (hereinafter called a cell) 12 is formed by a discharge space formed at a crossing region of an address electrode A and a pair of a scan and sustain electrodes Y, X.

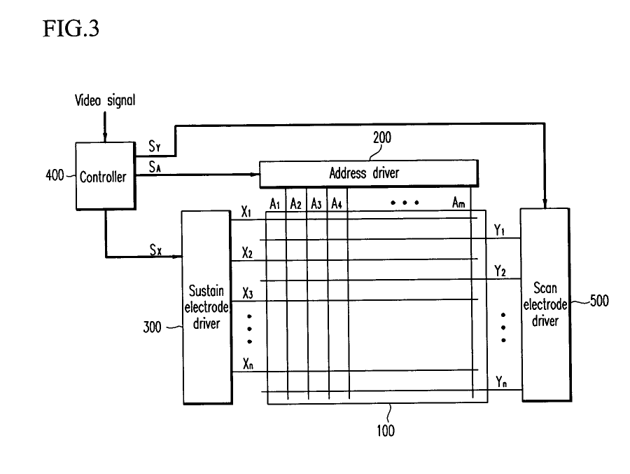

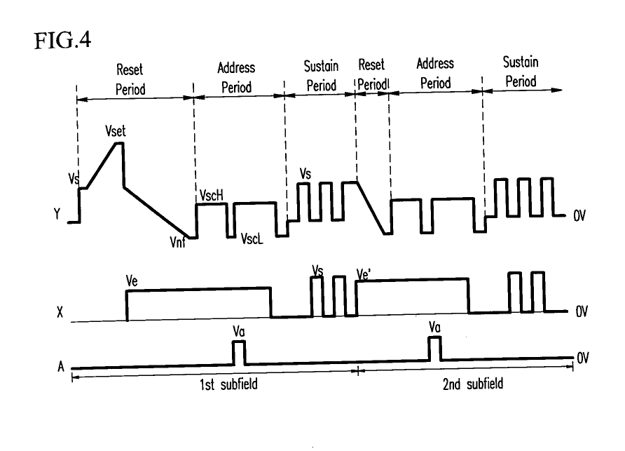

FIG. 3 is a schematic diagram of a plasma display device according to an embodiment of the present invention. A plasma display device according to an embodiment of the present invention includes a plasma panel 100, an address driver 200, a scan electrode driver 500, a sustain electrode driver 300, and a controller 400.

The plasma panel 100 includes the plurality of address electrodes A₁ to Aₘ extending along the column direction, and the scan electrodes Y₁ to Yₙ and the sustain electrodes X₁ to Xₙ extending both along the row direction.

The address driver 200 receives an address driving control signal S_{A} from the controller 400, and applies a voltage for selecting the turn-on cells to the address electrodes A₁ to Aₘ.

The scan electrode driver 500 and sustain electrode driver 300 respectively receive a scan electrode driving signal S_{Y} and a sustain electrode driving signal S_{X} from the controller 400, and apply them to the scan electrodes Y₁ to Yₙ and the sustain electrodes X₁ to Xₙ.

The controller 400, receiving video signals, generates the address electrode driving control signal S_{A}, the scan electrode driving signal S_{Y}, and the sustain electrode driving signal S_{X}, and applies them to the address driver 200, the scan electrode driver 500, and the sustain electrode driver 300, respectively.

In one embodiment, the controller 400 generates a control signal S_{X} for varying a level of the bias voltage applied to the sustain electrode X during the address period in accordance with a driving waveform of the reset period S_{Y} of each subfield, and supplies the control signal to the sustain electrode driver 300.

FIG. 4 illustrates a driving waveform of a plasma display device according to an embodiment of the present invention. Only two subfields among the plurality of subfields are shown for better comprehension and ease of description, and the two subfields are indicated as a first subfield and a second subfield. In addition, FIG. 4 illustrates a main reset period that includes a rising period and a falling period, and an auxiliary reset period that includes only a falling period.

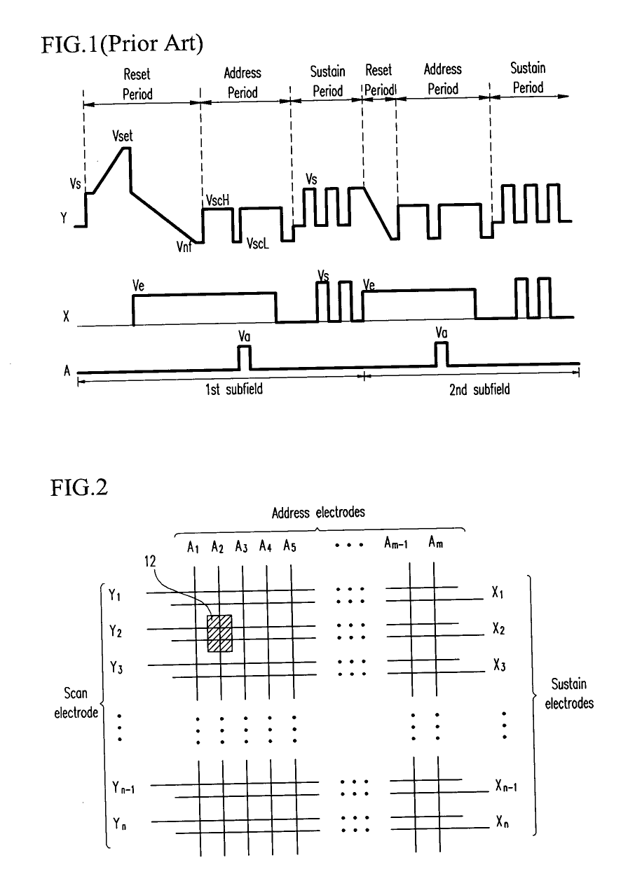

As shown in FIG. 4, a driving waveform of each subfield, according to an embodiment of the present invention, includes a reset period, an address period, and a sustain period. During the reset period of the first subfield, every cell experiences a discharge by a ramp voltage rising in the same manner as during the reset period of the first subfield shown in FIG. 1. As a result, negative charges are sufficiently accumulated on the scan electrode Y and positive charges are sufficiently accumulated on the address electrode A. Subsequently, a falling ramp voltage is applied to the scan electrode Y decreasing its voltage to a negative Vnf. In this case, the wall charges formed on the sustain electrode X by the rising ramp voltage of the scan electrode Y are erased, while wall charges formed on the address electrode A are maintained. That is, the wall charge distribution in the cell is changed by a falling ramp voltage to be appropriate for addressing during a subsequent address period.

During the subsequent address period, a scan operation is performed by sequentially applying a voltage VscL of a negative level to the scan electrodes Y for selecting the turn-on cells among all of the cells. During this scan operation, a voltage Va is applied to the address electrodes A of the turn-on cells, while all of the sustain electrodes X are biased at a constant voltage Ve. Therefore, in each turn-on cell, first a discharge is generated between the scan and address electrodes Y, A by scan and address pulses of the scan and address electrodes Y, A, and then another discharge is generated between the scan and sustain electrodes Y, X by the bias voltage Ve of the sustain electrode X. An address discharge is achieved by these two consecutive discharges during the address period. The level of the bias voltage Ve, applied to the sustain electrodes X during the address period, may be established as a voltage level that enables a stable discharge during the address period from a wall charge state remaining after a main reset period.

For realizing grayscales of the plasma display device during the sustain period, a discharge is generated in the cells selected during the address period, by applying a sustain discharge voltage of a level Vs alternately to the scan electrodes Y and the sustain electrodes X. The sustain discharge voltage Vs is applied such that when the scan electrode Y is at Vs, the sustain electrode X is not and when the sustain electrode X is at Vs, the scan electrode Y is not.

Subsequently during the auxiliary reset period, the voltage of the scan electrode Y is gradually decreased from the sustain discharge voltage Vs, applied to this electrode during the sustain period of the first subfield, to the voltage Vnf of a negative level. During such an auxiliary reset period, including only a falling period, a reset operation is performed only in the cells selected in a previous subfield as opposed to all of the cells.

Before application of the auxiliary reset waveform having only a falling period, the sustain discharge voltage Vs last applied to the scan electrode Y causes substantial amounts of negative (−) and positive (+) charges to accumulate on the scan and sustain electrodes Y, X, respectively. Positive (+) charges are also accumulated on the address electrodes A.

As described above, the reset period is for accumulating an appropriate amount of wall charges on the scan and address electrodes Y, A for facilitating an address discharge between these two electrodes during a subsequent address period. On the other hand, at the time of applying the auxiliary reset waveform to the scan electrode Y, a wall voltage is formed between the sustain and scan electrodes X, Y that is higher than the wall voltage between the address and scan electrodes A, Y. Due to this wall charge distribution, the falling ramp waveform may cause a discharge between the sustain and scan electrodes X, Y prior to a discharge between the address and scan electrodes A, Y. In this case, the wall charges between the sustain and scan electrodes X, Y take a principal role in the reset discharge such that wall charges appropriate for an addressing may not be formed between the address and scan electrodes A, Y, thus deteriorating an efficient address discharge. That is, during an auxiliary reset period, negative (−) and positive (+) wall charges respectively accumulated on the scan and address electrodes Y, A may be insufficient compared to the wall charges accumulated during a main reset period. These wall charges produce a wall voltage smaller than that necessary for an efficient discharge during the succeeding address period.

To remedy the above problem, following the auxiliary reset waveform and during the address period of the second subfield, a bias voltage Ve′ is applied to the sustain electrodes X. Ve′ is higher than the bias voltage Ve, applied to the sustain electrode X during the address period of the first subfield that follows a main reset waveform. Ve′ is a voltage level that enables a stable discharge during the address period after an auxiliary reset period. This stable discharge results due to the combined effects of Ve′ and the wall charge state remaining after an auxiliary reset period.

Finally, during the sustain period for realizing grayscales of the plasma display device, a discharge is generated in the cells selected during the address period, by alternately applying a sustain discharge voltage of a level Vs to the scan and sustain electrodes Y, X.

As described above, according to an embodiment of the present invention, the level of a bias voltage applied to the sustain electrodes X during an address period is varied in accordance with wall charge states that depend on the driving waveform applied during the preceding reset period.

In more detail, when the reset period includes both a rising and a falling period, for example as in the first subfield shown in FIG. 4, sufficient positive (+) wall charges may be formed at the end of the reset period. Therefore, the bias voltage applied to the sustain electrodes X during the address period of the first subfield is lower than the bias voltage applied during the address period of the second subfield. According to this scheme, excessive accumulation of wall charges may be prevented and misfiring of cells (i.e., firing of cells that are not to be turned on) may be prevented.

On the other hand, in the second subfield, because the auxiliary reset period includes only the falling ramp waveform without the rising ramp waveform, wall charges accumulated on the scan and address electrodes Y, A by the end of the reset period are insufficient. In this case, the address discharge may further deteriorate if a bias voltage of the same level as the bias voltage of the address period of the first subfield is applied to the sustain electrodes X during the second subfield as well. Therefore, when the reset period includes only the falling period, a bias voltage of a higher level is applied to the sustain electrodes X than the bias voltage applied during the address period of the first subfield. This higher bias voltage helps stabilize the address discharge.

When a frame is divided into subfields, the wall charge states at the beginning of the address periods may vary depending on the subfield and depending on the waveform applied during the reset period of each subfield. A stable address operation may be achieved by varying the level of the bias voltage applied to the sustain electrodes X during the address period based on the wall charge state.

As described above, according to an embodiment of the present invention, a defective address discharge caused by insufficient wall charges after a reset period having only a falling period may be prevented by varying a level of a bias voltage applied to the sustain electrodes during an address period depending on a driving waveform applied during the reset period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a plasma display panel by a plurality of subfields divided from a frame, the plasma display panel having scan electrodes and sustain electrodes forming parallel pairs, the plasma display panel further having address electrodes extending in a direction crossing the parallel pairs, the plasma display panel further having discharge cells formed in areas where the address electrodes cross the parallel pairs, each subfield including a reset period followed by an address period followed by a sustain period, the driving method comprising:
initializing every discharge cell during a reset period of a first subfield by applying a first voltage waveform to the scan electrodes;
selecting a first group of turn-on discharge cells during an address period of the first subfield by applying a second voltage waveform to the scan electrodes and applying a third voltage waveform to the address electrodes, while applying a fourth voltage waveform to the sustain electrodes;
initializing the first group of turn-on discharge cells during a reset period of a second subfield by applying a fifth voltage waveform to the scan electrodes; and
selecting a second group of turn-on discharge cells during an address period of the second subfield by applying the second voltage waveform to the scan electrodes and applying the third voltage waveform to the address electrodes, while applying a sixth voltage waveform to the sustain electrodes,
wherein the fourth voltage waveform includes a first constant bias voltage,
wherein the sixth voltage waveform includes a second constant bias voltage, and
wherein the second constant bias voltage is more positive than the first constant bias voltage.

2. The driving method of claim 1, wherein the first voltage waveform applied to the scan electrodes for initializing the every discharge cell includes during the first subfield a gradually increasing voltage and a gradually decreasing voltage.

3. The driving method of claim 2, wherein the gradually increasing voltage gradually increases to a positive voltage during the reset period of the first subfield.

4. The driving method of claim 2, wherein the fifth voltage waveform applied to the scan electrodes during the second subfield for initializing the turn-on discharge cells includes only a gradually decreasing voltage.

5. The driving method of claim 2, wherein the gradually decreasing voltage gradually decreases to a negative voltage during the reset period of the first subfield.

6. The driving method of claim 4, wherein the gradually decreasing voltage gradually decreases to a negative voltage during the reset period of the second subfield.

7. The driving method of claim 1, wherein the first constant bias voltage and the second constant bias voltage are both positive.

8. A plasma display device comprising:
a plasma display panel including scan electrodes, sustain electrodes, and address electrodes formed in a direction crossing the scan electrodes and the sustain electrodes, the plasma display device driven in frames, the frames including subfields; and
a driving circuit supplying a driving signal to the scan electrodes, the sustain electrodes, and the address electrodes during a subfield,
wherein each subfield includes a reset period followed by an address period followed by a sustain period,
wherein the driving circuit performs during a first subfield:
initializing every discharge cell during a reset period of the first subfield by applying a first voltage waveform to the scan electrodes;
selecting a first group of turn-on discharge cells during an address period of the first subfield by applying a second voltage waveform to the scan electrodes and applying a third voltage waveform to the address electrodes, while applying a fourth voltage waveform to the sustain electrodes;
wherein the driving circuit performs during a second subfield:
initializing the first group of turn-on discharge cells during a reset period of a second subfield by applying a fifth voltage waveform to the scan electrodes; and
selecting a second group of turn-on discharge cells during an address period of the second subfield by applying the second voltage waveform to the scan electrodes and applying the third voltage waveform to the address electrodes, while applying a sixth voltage waveform to the sustain electrodes,
wherein the fourth voltage waveform includes a first constant bias voltage,
wherein the sixth voltage waveform includes a second constant bias voltage, and
wherein the second constant bias voltage is more positive than the first constant bias voltage.

9. The plasma display device of claim 8, wherein the driving circuit applies during the reset period of the first subfield the first voltage waveform including a gradually increasing voltage and a gradually decreasing voltage to the scan electrodes.

10. The plasma display device of claim 9, wherein the gradually increasing voltage gradually increases to a positive voltage during the reset period of the first subfield.

11. The plasma display device of claim 9, wherein the driving circuit applies during the reset period of the second subfield the fifth voltage waveform including only a gradually decreasing voltage to the scan electrodes.

12. The plasma display device of claim 9, wherein the gradually decreasing voltage gradually decreases to a negative voltage during the reset period of the first subfield.

13. The plasma display device of claim 11, wherein the gradually decreasing voltage gradually decreases to a negative voltage during the reset period of the second subfield.

14. The plasma display device of claim 8, wherein the first constant bias voltage and the second constant bias voltage are both positive voltages.

15. A plasma display device comprising:
a controller for receiving a video signal from an external source and for generating a control signal;
a plasma display panel including pixels for displaying images, scan electrodes and sustain electrodes forming parallel pairs, address electrodes crossing the parallel pairs, discharge cells formed at crossings of the address electrodes and the parallel pairs, the plasma display device operating during frames, each frame including subfields, each subfield including a reset period followed by an address period, followed by a sustain period;
a scan electrode driver coupled to the controller and to the plasma display panel for receiving the control signal generated by the controller and for applying a scan voltage waveform to the scan electrodes;
an address electrode driver coupled to the controller and to the plasma display panel for receiving the control signal generated by the controller and applying an address voltage waveform to the address electrodes; and
a sustain electrode driver coupled to the controller and to the plasma display panel for receiving the control signal generated by the controller and for applying a sustain voltage waveform to the sustain electrodes,
wherein the controller varies the sustain voltage waveform of a subfield based on the scan voltage waveform of a previous subfield.

16. The plasma display device of claim 15,
wherein the scan voltage waveform applied during a reset period of a first subfield includes a rising voltage ramp and a falling voltage ramp,
wherein the scan voltage waveform applied during a reset period of a succeeding subfield includes only a falling voltage ramp,
wherein the sustain voltage waveform includes a first constant bias voltage level applied concurrent with the falling voltage ramp of the reset period of the first subfield,
wherein the sustain voltage waveform includes a second constant bias voltage level applied concurrent with the falling voltage ramp of the reset period of the second subfield, and
wherein the second constant bias voltage level is more positive than the first constant bias voltage level.

17. The plasma display device of claim 16,
wherein the falling voltage ramp applied during the reset period of the first subfield falls to a negative voltage by an end of the reset period of the first subfield, and
wherein the falling voltage ramp applied during the reset period of the second subfield falls to a negative voltage by an end of the reset period of the second subfield.

18. The plasma display device of claim 16, wherein the sustain voltage waveform of all subfields includes voltages alternating between a positive voltage and zero during the sustain period of the subfields.

19. The driving method of claim 1, wherein the first group of turn-on discharge cells and the second group of turn-on discharge cells are the same.

20. The plasma display device of claim 8, wherein the first group of turn-on discharge cells and the second group of turn-on discharge cells are the same.
